(19) United States
(12) Patent Application Publication
(10) Pub. No.: US 2018/0087494 A1
(43) Pub. Date: Mar. 29, 2018

(54) REFRIGERANT COMPRESSOR

(71) Applicant: Secop GmbH, Flensburg (DE)

(72) Inventors: Fabian BRUNE, Flensburg (DE); Helge STEEN, Buedelsdorf (DE)

(73) Assignee: Secop GmbH, Flensburg (DE)

(21) Appl. No.: 15/566,306

(22) PCT Filed: Apr. 15, 2016
(86) PCT No.: PCT/EP2016/058397

§ 371 Date: Oct. 13, 2017

(30) Foreign Application Priority Data
Apr. 15, 2015 (AT) GM50062/2015

(51) Int. Cl. F04B 39/00; C08J 5/18; F04B 17/03; F04B 39/12

(52) U.S. Cl. CPC F04B 39/0044; C08J 5/18; C08J 2307/00; F04B 39/0027; F04B 39/126; F04B 17/03

(57) ABSTRACT

Refrigerant compressor including a hermetically sealed housing and a drive unit arranged in the housing with a piston/cylinder unit for cyclical compression of a refrigerant, and an electric motor for driving the piston/cylinder unit. A damping device is provided in the interior of the housing, the damping device including an inner element connected to the drive unit and an outer element which surrounds the inner element. A movement volume is provided in the housing, in which movement volume the inner element and the outer element are arranged. At least the inner element can be moved in the movement volume in a first state of the drive unit, and the inner element is pressed against the wall element with the interposition and elastic deformation of the outer element in a second, deflected state of the drive unit.

### FIELD OF THE INVENTION

The present invention relates to a refrigerant compressor comprising a hermetically sealed housing and a drive unit disposed in the interior of the housing, having a piston/cylinder unit for cyclical compression of a refrigerant, and an electric motor for drive of the piston/cylinder unit, wherein a damping apparatus for damping and limiting a deflection of the drive unit is provided in the interior of the housing, the damping apparatus comprising an inner element, which is connected with the drive unit, and an outer element, which surrounds the inner element, wherein a movement volume that is limited, at least in certain sections, by means of at least one wall element, is provided in the housing, in which movement volume the inner element and the outer element are disposed, wherein in a first state of the drive unit, at least the inner element can be moved in the movement volume, and wherein in a second, deflected state of the drive unit, the inner element is pressed against the at least one wall element, with interposition and elastic deformation of the outer element.

### STATE OF THE ART

In the case of refrigerant compressors that comprise a hermetically sealed housing and a drive unit disposed in the interior of the housing, having a piston/cylinder unit for cyclical compression of a refrigerant, and an electric motor for drive of the piston/cylinder unit, relatively great forces occur, particularly during start and stop procedures, which forces lead to correspondingly relatively great deflections of the drive unit in the housing. In this regard, the drive unit is connected with the housing for vibration damping, usually by way of spring elements, which permit deflection of the drive unit. Particularly in the case of refrigerant compressors having a variable speed of rotation, the spring elements must be designed in relatively soft manner because of the low speeds of rotation that occur during operation, and this in turn results in greater deflections of the drive unit. A damping apparatus is provided in order to prevent contact of the drive unit with the housing in this connection.

This damping apparatus, according to the state of the art, has a cap that is disposed in the housing interior and rigidly connected with the housing—typically welded to the housing—which cap defines a movement volume. A spiral-shaped metal spring is attached in the cap. A metal bolt is disposed in a clear cross-section of the metal spring, which bolt is rigidly connected with the drive unit. The metal bolt can move within a certain range within the clear cross-section, without touching the metal spring. In normal operation, this allows a certain deflection of the drive unit. At very great deflections, as they particularly occur during start and stop procedures, the bolt touches the spring, causing it to be elastically deformed and pressed against the cap. This damps and limits the deflection of the drive unit.

A disadvantage in this regard is the relatively great noise development. The contact of metal on metal due to contacting of the spring by the bolt contributes to this. Furthermore, the sound is transferred very well to the cap, and from the cap to the housing. The noise generated in this way is subjectively perceived by the user as bothersome.

### TASK OF THE INVENTION

It is therefore the task of the invention to provide a refrigerant compressor that avoids the disadvantages mentioned above. In particular, the refrigerant compressor according to the invention is supposed to prevent or at least minimize disruptive noise development, as it preferentially occurs in start and stop procedures of refrigerant compressors having a variable speed of rotation.

### PRESENTATION OF THE INVENTION

It is the core of the invention to further improve the damping properties and, in this regard, to particularly prevent metallic noises, in that a damping element composed of a polymer material or of vulcanized rubber is provided. In this regard, a polymer material is understood to mean a material or plastic in accordance with DIN 7724, which comprises duroplastics, elastomers, thermoplastics and thermoplastic elastomers. From what has been said, it is evident that rubber, which can be produced both from a natural material and from a synthetic material, is a possible material for the damping element. The damping element, as an outer element, surrounds an inner element, which in turn is connected with the drive unit. The inner element can—but does not have to—be significantly more rigid than the outer element. Accordingly, it is provided, according to the invention, in the case of a refrigerant compressor comprising a hermetically sealed housing and a drive unit disposed in the interior of the housing, having a piston/cylinder unit for cyclical compression of a refrigerant, and an electric motor for drive of the piston/cylinder unit, wherein a damping apparatus for damping and limiting a deflection of the drive unit is provided in the interior of the housing, the damping apparatus comprising an inner element, which is connected with the drive unit, and an outer element, which surrounds the inner element, wherein a movement volume that is limited, at least in certain sections, by means of at least one wall element is provided in the housing, in which movement volume the inner element and the outer element are disposed, wherein in a first state of the drive unit, at least the inner element can be moved in the movement volume, and wherein in a second, deflected state of the drive unit, the inner element is pressed against the at least one wall element, with interposition and elastic deformation of the outer element, that the outer element is produced from a polymer material or vulcanized rubber. In this regard, it does not play any role whether the outer element is fixed in place on the at least one wall element or not.

Furthermore, the formation of the at least one wall element can also take place in the most varied manner. One possibility consists in using caps, something that can be particularly advantageous in terms of production technology and thereby with regard to costs. Therefore it is provided, in a preferred embodiment of the refrigerant compressor according to the invention, that the at least one wall element is part of a cap disposed in the housing and rigidly connected with the latter. The use of caps is also advantageous in that this allows more flexible shaping of the housing, as long as it is ensured that at least one cap or multiple caps can be disposed in the housing and connected with it in essentially rigid manner. Preferably, the at least one cap is welded to the housing.

In order to make possible an embodiment variant that can be implemented in particularly simple manner, it is provided, in a preferred embodiment of the refrigerant compressor according to the invention, that the outer element is fixed in place on the at least one wall element. In particular, the outer element can be fixed in place on the cap, in this connection. In this case, the inner element, in normal operation, can freely move in a region that is surrounded by the outer element, in accordance with the deflections of the drive unit. Only in the case of very great deflections does the inner element touch the outer element and deform it by pressing it against the wall element, particularly against the cap.

In order to achieve progressive damping, it is provided, in a preferred embodiment of the refrigerant compressor according to the invention, that the outer element has an inner side that faces the inner element, which side delimits a clear cross-section of the outer element, and that the clear cross-section narrows, at least in certain sections, viewed parallel to a longitudinal axis of the outer element. The narrowing brings about the result that the inner element at first contacts only part of the outer element in the event of very great deflections of the drive unit, namely the part that has the smallest clear cross-section. Accordingly, only this part of the outer element is elastically deformed by the inner element at first. If this is not sufficient to limit the deflection of the drive unit, then in the event of increased deflection, contacting, by the inner element, of further parts of the outer element that delimit the clear cross-section comes about. The more parts are contacted, the greater the force required for further deformation of the outer element by the inner element, bringing about progressive damping. If no deflection of the drive unit is present, then the longitudinal axis of the outer element preferably lies parallel to a longitudinal axis of the inner element.

In order to allow particularly uniform and soft response of the progressive damping, it is provided, in a preferred embodiment of the refrigerant compressor according to the invention, that the clear cross-section narrows, viewed parallel to the longitudinal axis and in the direction of a center of the outer element that lies on the longitudinal axis, and increases in size in the opposite direction. Preferably, the center of the outer element coincides with the center of the movement volume, so that the clear cross-section having the smallest size is disposed in the center of the movement volume. Furthermore, by means of the said shaping of the clear cross-section, particularly uniform damping behavior can be guaranteed, even if the longitudinal axis of the inner element does not run parallel to the longitudinal axis of the outer element. The latter can occur, for example, if rotation of the drive unit, preferably slight rotation, comes about during the course of its deflection.

In order to make particularly simple production of the outer element having the narrowing clear cross-section possible, it is provided, in a preferred embodiment of the refrigerant compressor according to the invention, that the clear cross-section narrows in steps.

In order to make a stable intermediate position of the outer element between the inner element and the at least one wall element possible, and, at the same time, in order to be able to guarantee simple and stable fixation of the outer element on the at least one wall element, it is provided, in a preferred embodiment of the refrigerant compressor according to the invention, that the outer element has an outer side that surrounds the inner element, in certain sections, and faces away from the inner element, which side is fixed in place, at least in certain sections, on the at least one wall element.

In a preferred embodiment of the refrigerant compressor according to the invention, it is provided that the outer element has an outer side that surrounds the inner element, in certain sections, and faces away from the inner element, which outer side contacts the at least one wall element in certain sections, in the first state of the drive unit, and is spaced apart from the at least one wall element, in certain sections. In that the outer side does not lie completely against the at least one wall element, damping in a starting phase can be configured to be relatively soft. This is because the spacing offers room for the outer element to be able to deform without contacting the at least one wall element in the case of a certain size of the deflections of the drive unit, at first, and this brings about relatively slight damping at first. Only in the case of greater deflections is the outer element pressed against the at least one wall element, and this brings about stronger damping.

In a preferred embodiment of the refrigerant compressor according to the invention, it is provided that the outer element has an outer side that surrounds the inner element in certain sections, and faces away from the inner element, which outer side overlaps with the at least one wall element, viewed parallel to the longitudinal axis, only in certain sections. In this way, particularly soft response behavior of the damping can be implemented in specific situations, if the inner element at first contacts only that part of the outer element that does not overlap with the at least one wall element, viewed parallel to the longitudinal axis, because this part of the outer element cannot be pressed against the wall. Of course, elastic deformation of this part of the outer element can come about nevertheless, bringing about slight damping of the corresponding deflection of the drive unit. Subsequently, in the case of even greater deflections, it can come about that then, also those parts of the outer element that overlap with the at least one wall element, viewed parallel to the longitudinal axis, are contacted by the inner element and elastically deformed by this element, leading to stronger damping and stronger limitation of the deflection of the drive unit. In total, once again a progressive damping characteristic can therefore be achieved.

In a preferred embodiment of the refrigerant compressor according to the invention, it is provided that the at least one wall element is part of a housing wall of the housing. In this case, no additional components, particularly no caps for forming the at least one wall element are necessary. Aside from the fundamental elegance of this solution, in this case the housing can also be kept particularly compact, since no additional caps have to be accommodated, something that would be advantageous for applications with constricted space conditions. It only needs to be ensured that the housing wall is suitably shaped in certain sections, in order to delimit the movement volume, at least in certain sections. Furthermore, this solution, of course, also offers a cost saving potential that cannot be underestimated, because of the reduced number of parts.

In a preferred embodiment of the refrigerant compressor according to the invention, it is provided that the outer element is fixed in place on the inner element. In this regard, the at least one wall element can be formed by the cap. Preferably, the at least one wall element is formed by the housing wall. Accordingly, an advantage of fixation of the outer element on the inner element lies in that this can be used universally in the most varied embodiment variants of the at least one wall element. Furthermore, that surface of the outer element that experiences elastic deformation for damping of the deflection of the drive unit and/or with which the outer element contacts the at least one wall element for damping of the deflection of the drive unit, can be configured to be particularly large, and this allows very strong and effective damping of the deflection of the drive unit.

Furthermore, a maximal contact surface between the two elements can always be guaranteed by means of attachment of the outer element on the inner element, and this also contributes to very strong and effective damping of the deflection of the drive unit. Accordingly, it is provided, in a preferred embodiment of the refrigerant compressor according to the invention, that the outer element has an inner side that faces the inner element, which side is completely contacted by the inner element.

In order to improve the elastic behavior of the outer element in the sense of a more precise or softer response of the damping, it is provided, in a preferred embodiment of the refrigerant compressor according to the invention, that the outer element has lamellae that contact the at least one wall element in the second state of the drive unit. In other words, at first elastic deformation of individual lamellae takes place at sufficiently great deflections of the drive unit, thereby making a soft response of the damping possible. Only at even greater deflections can elastic deformation of the remaining parts of the outer element, which do not have any lamellae, particularly of a basic body of the outer element, come about, and this brings about stronger damping. In total, once again, a progressive damping characteristic can be achieved. In this regard, it is preferably provided, for reinforcement of the progressive damping characteristic, that an envelope of the outer element is curved, at least in certain sections, so as to face away from the at least one wall element.

In order to make particularly simple production of the lamellae possible, it is provided, in a preferred embodiment of the refrigerant compressor according to the invention, that the lamellae project from a basic body of the outer element in a normal line relative to the longitudinal axis.

In particular, embodiment variants are also possible, in which the inner element and the outer element are produced in one piece and thereby from the same material. Then, of course, the outer element and the inner element fundamentally demonstrate the same rigidity. Accordingly, it is provided, in a preferred embodiment of the refrigerant compressor according to the invention, that the outer element and the inner element are structured in one piece.

In order to make particularly simple assembly of the refrigerant compressor, particularly of the damping apparatus, possible, and furthermore to ensure a long useful lifetime, particularly of the outer element, it is provided, in a preferred embodiment of the refrigerant compressor according to the invention, that the outer element is structured in one piece.

In order to be able to transfer and damp the deflection of the drive unit particularly directly, it is provided, in a preferred embodiment of the refrigerant compressor according to the invention, that the inner element is produced from metal. At the same time, great stability and a long useful lifetime of the inner element is guaranteed in this way. Preferably, the inner element is structured as a bolt in this connection. Particularly preferably, the inner element is fixed in place in a block of the drive unit, which block functions as an additional mass of the drive unit, in order to lower the frequency of inherent oscillations of the drive unit.

### BRIEF DESCRIPTION OF THE FIGURES

The invention will now be explained in greater detail using exemplary embodiments. The drawings are meant as examples and are supposed to present the idea of the invention, but by no means to restrict it or to reproduce it in final manner.

In this regard, the figures show:

FIG. 1 a sectional view through a refrigerant compressor according to the state of the art,

FIG. 2 to FIG. 7 in each instance, a schematic sectional representation through a damping apparatus of different embodiments of a refrigerant compressor according to the invention, wherein an outer element of the damping apparatus is fixed in place on a wall element,

FIG. 8 a schematic sectional representation through a damping apparatus of an embodiment of a refrigerant compressor according to the invention, wherein the outer element is fixed in place on an inner element of the damping apparatus,

FIG. 9 a schematic sectional representation through a damping apparatus of an embodiment of a refrigerant compressor according to the invention, wherein the outer element is fixed in place on an inner element of the damping apparatus, and wherein no cap is provided,

FIG. 10 a schematic sectional representation through a damping apparatus of an embodiment of a refrigerant compressor according to the invention, wherein the outer element is fixed in place both on the inner element of the damping apparatus and on a wall element,

FIG. 11 a view analogous to FIG. 10, wherein, however, the inner element is shown in a deflected state.

### WAYS FOR IMPLEMENTATION OF THE INVENTION

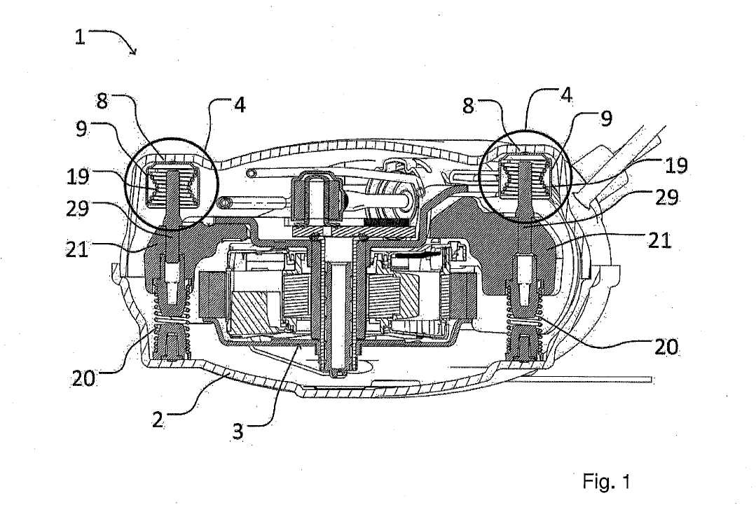

A refrigerant compressor 1 according to the state of the art is shown in the sectional view of FIG. 1, wherein this particularly involves a refrigerant compressor 1 with a variable speed of rotation. The refrigerant compressor 1 has a hermetically sealed housing 2, as well as a drive unit 3 disposed in the interior of the housing 2, having a piston/cylinder unit for cyclical compression of a refrigerant, and an electric motor for drive of the piston/cylinder unit. The drive unit 3 is connected with the housing 2 by means of spring elements 20, for vibration damping, so that deflections of the drive unit 3 can come about, particularly during start and stop procedures. Damping apparatuses 4 are provided in the interior of the housing 2 in order to prevent the drive unit 3 from making contact with the housing 2 in this connection.

According to the state of the art, each damping apparatus 4 comprises a cap 9, which is rigidly connected with, preferably welded to, the housing 2 or a housing wall 8. A spiral-shaped metal spring 19 is attached in each cap 9. A bolt 29, preferably composed of metal and connected with the drive unit 3 in essentially rigid manner, is disposed in a clear cross-section of the respective metal spring 19.

Every movement or deflection of the drive unit 3 therefore brings about a corresponding deflection of the bolt 29. Preferably, the bolt 29 is fixed in place in a block 21 of the drive'unit 3, which block functions as an additional mass of the drive unit 3, in order to lower the frequency of natural oscillations of the drive unit 3.

The bolt 29 can move in a certain region within the clear cross-section without touching the metal spring 19. In normal operation, this makes a certain deflection of the drive unit 3 possible. At very great deflections, such as they occur, in particular, during start and stop procedures, the bolt 29 touches the metal spring 19, thereby causing the spring to be elastically deformed and pressed against the cap 9. This damps and limits the deflection of the drive unit 3, but at the same time results in undesirable noise development, with bothersome metallic noises.

For reduction of the noise development, a refrigerant compressor 1 according to the invention has damping apparatuses 4, which each comprise an outer element 6 composed of a polymer material or vulcanized natural rubber, particularly composed of rubber. The damping apparatus 4 of the refrigerant compressor 1 according to the invention furthermore has an inner element 5, which is connected with the drive apparatus 3 and surrounded by the damping element 6. The inner element 5 can have a greater rigidity than the damping element 6 and can be structured as a bolt or pin, for example, particularly composed of metal. Preferably, the inner element 5 is fixed in place in the block 21 of the drive unit 3.

The outer element 6 and the inner element 5 are disposed in a movement volume 7, which is delimited, at least in certain sections, by means of at least one wall element. In a first state of the drive unit 3, which corresponds to the normal operating state, at least the inner element 5 can be moved in the movement volume 7. In a second, deflected state of the drive unit 3, which corresponds to a relatively great deflection of the drive unit 3, the inner element 5 is also deflected to a correspondingly great extent, and presses against the at least one wall element, with interposition and elastic deformation of the outer element 6.

Independent of the material selection of the inner element 5, as well as of the at least one wall element, contact of metal on metal is prevented in the second state, in any case, by means of the material of the outer element 6. Furthermore, excellent damping of the deflection of the drive unit 3 is achieved by means of the elastically deforming material of the outer element 6. In total, contact of the drive unit 3 with the housing 2 can thereby be prevented, and bothersome noise development, particularly during start and stop procedures, can be drastically reduced.

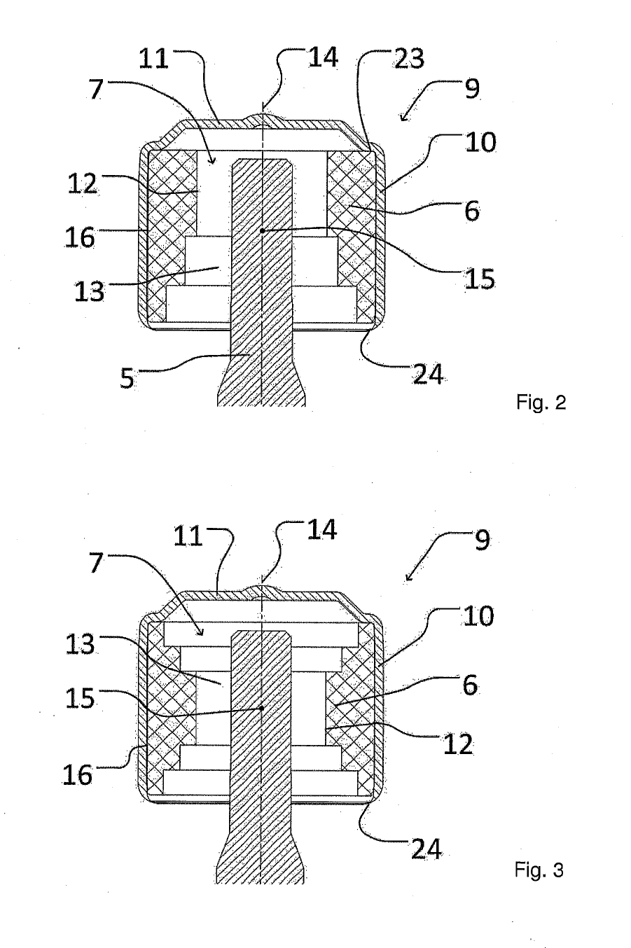

A damping apparatus 4 of an embodiment of the refrigerant compressor 1 according to the invention is shown in the schematic sectional view of FIG. 2, in which embodiment the damping apparatus 4 comprises a cap 9, which is rigidly connected with, preferably welded to the housing 2 or the housing wall 8. In this case, the at least one wall element, which delimits the movement volume 7, at least in certain sections, is therefore formed by at least one side wall 10 of the cap 9, which wall encloses the outer element 6, as well as by a head wall 11 of the cap 9. In the exemplary embodiment shown, the outer element 6 is fixed in place on the at least one side wall 10 and/or on the head wall 11, for example by means of gluing. The side wall 10 and head wall 11 can fundamentally be structured in one piece. Preferably, the outer element 6 is particularly fixed in place on the at least one side wall 10 with an outer side 16, which surrounds the inner element 5 in certain sections and faces away from the inner element 5.

The outer element 6 has an inner side 12 that faces the inner element 5 and delimits a clear cross-section 13 of the outer element 6. As can be seen in FIG. 2, the clear cross-section 13 narrows in a direction viewed parallel to a longitudinal axis 14 of the outer element 6. In this way, a progressive damping characteristic is achieved, since at first only part of the inner side 12 or of the outer element 6 is contacted by the inner element 5, pressed against the side wall 10, and elastically deformed in the case of sufficiently great deflections of the drive unit. Only at greater deflections are further parts of the inner side 12 or of the outer element 6 contacted by the inner element 5 and pressed against the side wall 10, wherein an increased expenditure of force is required for their elastic deformation, bringing about the progressive damping.

For simple production, the narrowing of the clear cross-section 13 is carried out in steps. The smallest size of the clear cross-section 13 is disposed in a center 15 of the outer element 6 in the embodiment of FIG. 2, which center lies on the longitudinal axis 14 and coincides with a center of the movement volume 7. In total, steps having three different sizes of the clear cross-section 13 or having three different distances of the inner side 12 from the longitudinal axis 14 can be seen.

FIG. 3 shows a further embodiment of the refrigerant compressor 1 according to the invention, wherein its damping apparatus 4 is structured fundamentally analogous to the exemplary embodiment of FIG. 2. In this case, however, the situation is that the clear cross-section 13 narrows, viewed parallel to the longitudinal axis 14 and in the direction of the center 15, and increases in size, viewed in the opposite direction. In this way, soft and uniform response of the progressive damping is achieved, even if a longitudinal axis 28 of the inner element 5 does not run parallel to the longitudinal axis 14 of the outer element 6. The latter can occur, for example, if a rotation of the drive unit 3, preferably a slight rotation, comes about during the course of its deflection. In FIG. 3, the longitudinal axis 28 of the inner element 5 is congruent with the longitudinal axis 14 of the outer element 6, and for this reason, it is not specifically shown in the drawing. The narrowing of the clear cross-section 13 takes place in steps in the exemplary embodiment of FIG. 3, as well. In total, steps having three different sizes of the clear cross-section 13 or having three different distances of the inner side 12 from the longitudinal axis 14 can be seen.

The embodiment of FIG. 5 has narrowing of the clear cross-section 13 with only one step. In this regard, the clear cross-section 13 has the smallest size in the region of a first end 22 of the outer element 6 that lies opposite the head wall 11, and widens in the direction toward a second end 23 of the outer element 6, which lies opposite the first end 22, i.e. in the direction toward the head wall 11 and parallel to the longitudinal axis 14. The part of the inner side 12 that delimits the clear cross-section 13 having the smallest size extends parallel to the longitudinal axis 14 only over approximately 22% of the entire expanse of the outer element 6, parallel to the longitudinal axis 14. The resulting damping characteristic is characterized by soft response and moderate damping in the case of deflections of the drive unit 3, which lead to first contact of the inner element 5 with the inner side 12, and to a relatively abrupt change to relatively strong damping and limitation of the deflection, as soon as the inner element 5 contacts further parts of the inner side 12.

The embodiments shown in FIG. 4 and FIG. 6 are examples of a clear cross-section 13 that is constant over the entire expanse of the outer element 6, parallel to the longitudinal axis 14. In order to not structure the damping to be too hard, in these cases the outer side 16 does not lie completely against the at least one side wall 10, but rather only in the region of the first end 22 and of the second end 23. Between these regions, the outer side 16 is at a distance from the at least one side wall 10. In the case of the embodiment of FIG. 4, this spacing is structured in steps, so that the part of the outer wall 16 that is at a distance from the side wall 10 runs essentially parallel to the side wall 10. In the case of the embodiment of FIG. 6, the spacing is implemented by means of a curvature of the outer side 16 that faces away from the side wall 10.

In the embodiments of FIG. 2 to FIG. 6, the outer element 6 is additionally held in the cap 9, in the direction parallel to the longitudinal axis 14, by means of shape fit. On the one hand, this shape fit comes about in that the outer element 6 lies against the head wall 11 of the cap 9 with its second end 23. On the other hand, the at least one side wall 10 has a bent end region 24 that lies opposite the head wall 11, which region is bent toward the longitudinal axis 14 and against which region the first end 22 of the outer element 6 lies in certain sections, with a region that follows the outer side 16.

In the embodiment of FIG. 7, the outer element 6 is also held in the cap 9 with shape fit parallel to the longitudinal axis 14. Once again, the second end 23 lies against the head wall 11 of the cap 9. In this regard, the outer element 6 is structured continuously in the region of the second end 23, without any clear cross-section 13. Furthermore, the outer side 16 of the outer element 6 overlaps with the at least one side wall 10 only in a restricted region 25, viewed parallel to the longitudinal axis 14. This region 25, as compared with a region 27 of the outer element 6 that follows it, which region does not overlap with the side wall 10, viewed parallel to the longitudinal axis 14, has a projection 26 that faces away from the longitudinal axis 14. With this projection 26, the outer element 6 contacts the bent end region 24 of the side wall 10, thereby completing the said shape fit. In addition, the outer element 6 can also be fixed in place on the side wall 10 and/or the head wall 11 in another manner, for example by means of gluing.

The outer element 6 has the clear cross-section 13 both in the region 25 and in the region 27. In this way, in certain situations, particularly if the longitudinal axis 28 of the inner element 5, as shown in FIG. 7, is not oriented parallel to the longitudinal axis 14, particularly soft response behavior of the damping can be implemented. Starting from a certain size of the deflections of the drive unit 3, the inner element 5 at first contacts the outer element 6 only in the region 27, but as a result, this region 27 is not pressed against the side wall 10, but rather only elastically deformed, and this in turn brings about little damping of the corresponding deflection of the drive unit 3. Subsequently, in the case of even greater deflections, it can come about that the inner element 5 then contacts the outer element 6 even in the region 25 and presses this region against the side wall 10, with elastic deformation, and this leads to stronger damping and to stronger limitation of the deflection of the drive unit 3. In total, therefore, a progressive damping characteristic can be achieved once again.

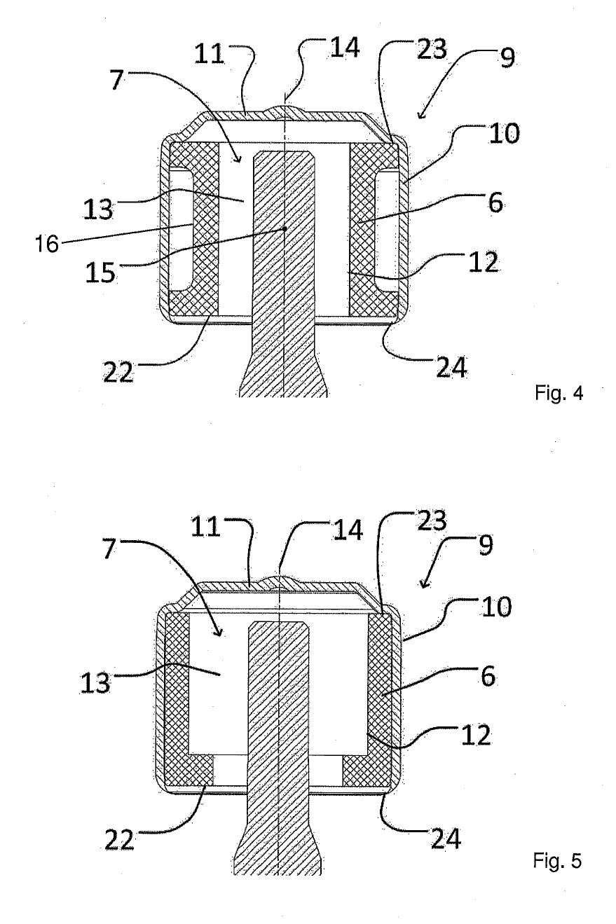

FIG. 8 shows an embodiment in which the outer element 6 is fixed in place on the inner element 5, for example by means of gluing or a press fit. In order to guarantee a maximal contact surface between the two elements 5, 6 in this regard, the entire inner side 12 of the outer element 6 contacts the inner element 5. Along with the secure hold of the outer element 5 on the inner element 5, this contributes to very strong and effective damping of the deflection of the drive unit 3. However, in the embodiment of FIG. 8, the at least one wall element is furthermore formed by the head wall 11 and the at least one side 10 of the cap 9.

It should be noted that variants are also possible, in which the inner element 5 and the outer element 6 are produced in one piece and therefore from the same material (not shown). Of course, the outer element 6 and the inner element 5 then have fundamentally the same rigidity.

In the embodiment of FIG. 8, the outer element 6 has lamellae 17 in order to achieve a progressive damping characteristic. These lamellae 17 project away from a basic body 18 of the outer element 6, preferably at a right angle to the longitudinal axis 14, wherein the basic body 18 has the inner side 12. At first, elastic deformation of individual lamellae 12 takes place in the case of sufficiently great deflections of the drive unit 3, thereby making soft response of the damping possible. Only at even greater deflections can elastic deformation of the basic body 18 come about, bringing about stronger damping. In total, a progressive damping characteristic can thereby be achieved once again. In this regard, it is preferably provided, in order to reinforce the progressive damping characteristic, that an envelope 30 (indicated with a broken line in FIG. 8) of the outer element 6 is curved so as to face away from the at least one side wall 10, at least in certain sections. The curvature brings about the result that not all the lamellae 17 contact the side wall 10 at the same time. Instead, more and more lamellae 17 successively contact the side wall 10 as the deflection of the drive unit 3 becomes ever greater.

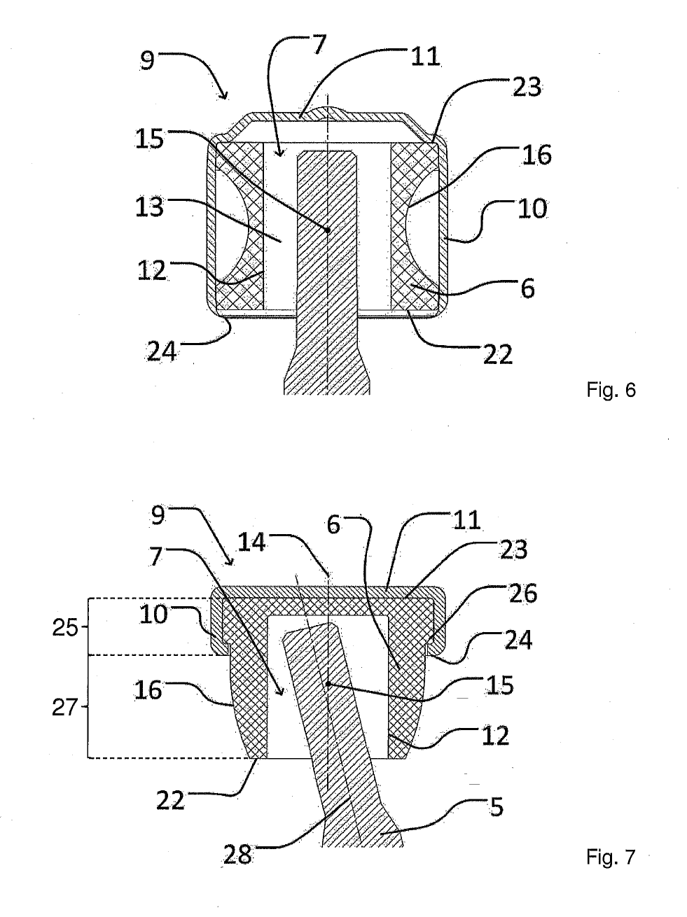

FIG. 9, finally, shows an embodiment in which the outer element 6 is also fixed in place in the inner element 5. However, in this case there is no cap 9. Instead, the at least one wall element is formed by the housing wall 8. The housing wall 8 is suitably shaped accordingly, in order to limit the movement volume 7 at least in certain sections.

In the exemplary embodiment of FIG. 9, the outer element 6 is not structured to be solid. Instead, the outer element 6 has an inner wall 32 that in turn has the inner side 12 that lies against the inner element 5. Furthermore, the outer element 6 has an outer wall 31, with which the outer element 6 contacts the housing wall 8 in the second state of the drive unit 3. A recess 33 of the outer element 6 is is provided between the two walls 31, 32. The recess 33 facilitates the deformation of the outer element 6 in the region of its outer wall 32 in the second state of the drive unit 3, and this makes softer damping possible. Furthermore, the recess contributes to a reduction in the mass of the outer element 6, as well as to material savings, in general.

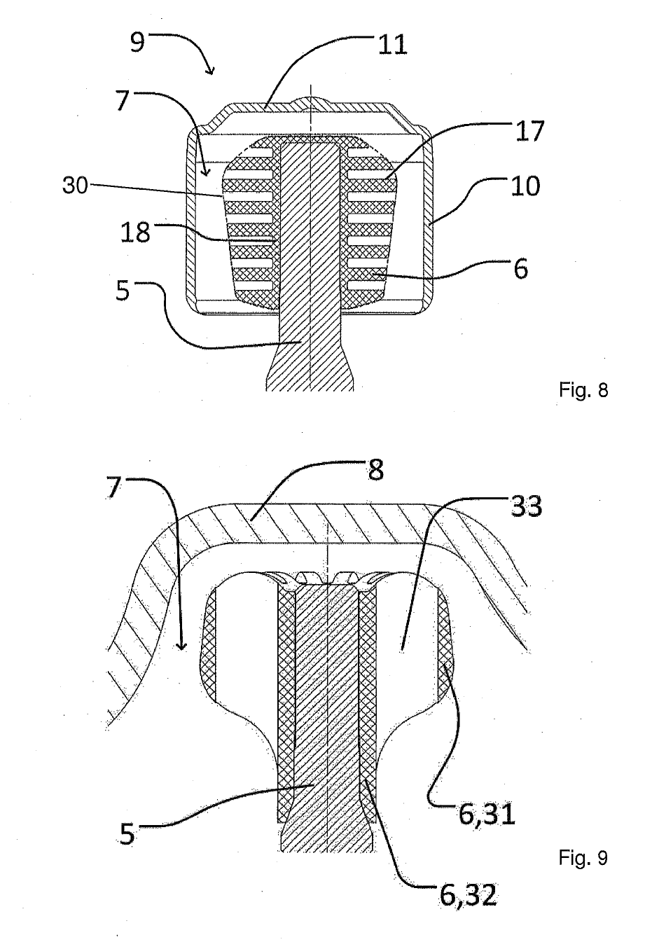

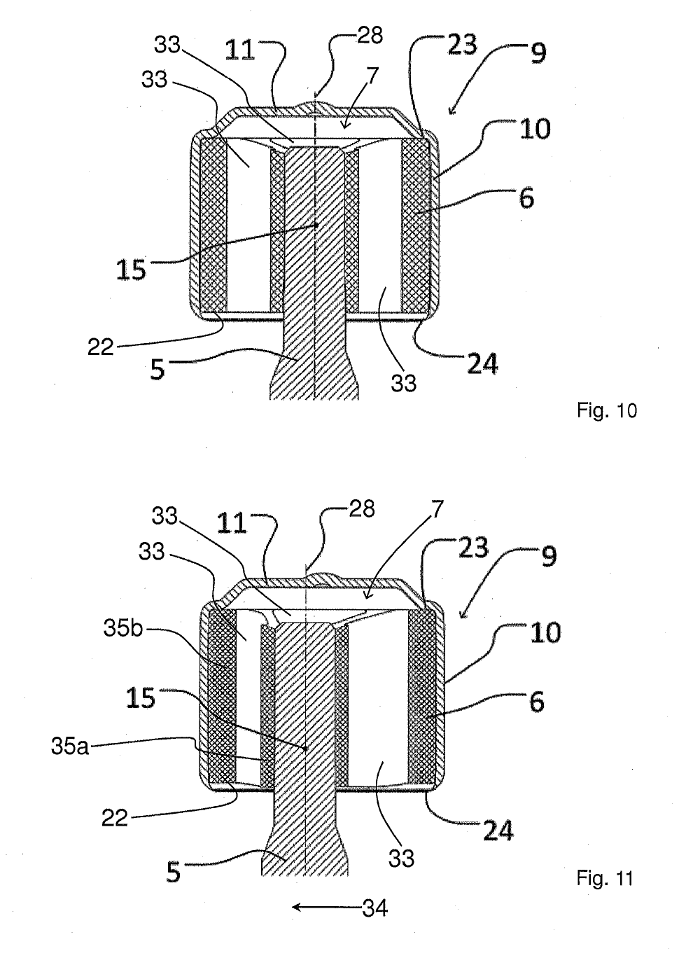

In the exemplary embodiment of FIG. 10 and FIG. 11, as well, the outer element 6 is not structured to be solid, but rather has recesses 33 that facilitate a deformation of the outer element 6. In this regard, the outer element 6 is attached both to the inner element 5 and to the side wall 10 of the cap 9. The side wall 10 and the head wall 11 of the cap 9 delimit the movement volume 7 at least in certain sections. FIG. 10 shows the non-deflected state. Because of the recesses 33, at least small movements of the inner element 5 are possible—with only slight elastic deformation of the outer element 6 in the region of the inner element 5—without noticeable pressing against the side wall 10 coming about.

FIG. 11 shows a second, clearly deflected state, in which the inner element 5 presses against the side wall 10, with interposition and elastic deformation of the outer element 6. In this regard, the deflection of the first element 5 shown in FIG. 11 is such that the longitudinal axis 28 of the element, as compared with the non-deflected state, is displaced parallel only in a deflection direction 34. Of course, however, deflections in which the longitudinal axis 28 is also tilted as compared with the non-deflected state are also possible.

In the second state, progressive damping behavior can be achieved by means of the recesses 33 if at first, as shown in FIG. 11, in spite of clear deflection, sections 35a, 35b of the outer element 6, which are disposed one behind the other, viewed in the deflection direction 34, are still separated from one another by a recess 33. In the case of even greater deflection in the deflection direction 34, contact of the sections 35a, 35b comes about. Then, even greater deflections in the deflection direction 34 require clearly greater forces, in order to make further (elastic) deformations of the outer element 6, and thereby a progressive damping characteristic exists.

### REFERENCE SYMBOL LIST

1 refrigerant compressor

2 housing

3 drive unit

4 damping apparatus

5 inner element

6 outer element

7 movement volume

8 housing wall

9 cap

10 side wall of the cap

11 head wall of the cap

12 inner side of the outer element

13 clear cross-section of the outer element

14 longitudinal axis of the outer element

15 center of the outer element

16 outer side of the outer element

17 lamella

18 basic body of the outer element

19 metal spring

20 spring element

21 block of the drive unit

22 first end of the outer element

23 second end of the outer element

24 bent end region of the side wall

25 region of the outer element that overlaps the side wall

26 projection of the region of the outer element that overlaps the side wall

27 region of the outer element that does not overlap the side wall

28 longitudinal axis of the inner element

29 bolt

30 envelope of the outer element

31 outer wall of the outer element

32 inner wall of the outer element

33 recess of the outer element

34 deflection direction

35a, 35b section of the outer element

1: Refrigerant compressor (1) comprising a hermetically sealed housing (2) and a drive unit (3) disposed in the interior of the housing (2), having a piston/cylinder unit for cyclical compression of a refrigerant, and an electric motor for drive of the piston/cylinder unit, wherein a damping apparatus (4) for damping and limiting a deflection of the drive unit (3) is provided in the interior of the housing (2), the damping apparatus (4) comprising an inner element (5), which is connected with the drive unit (3), and an outer element (6), which surrounds the inner element (5), wherein a movement volume (7) that is limited, at least in certain sections, by means of at least one wall element (8, 10, 11), is provided in the housing (2), in which movement volume (7) the inner element (5) and the outer element (6) are disposed, wherein in a first state of the drive unit (3), at least the inner element (5) can be moved in the movement volume (7), and wherein in a second, deflected state of the drive unit (3), the inner element (5) is pressed against the at least one wall element (8, 10, 11), with interposition and elastic deformation of the outer element (6), wherein the outer element (6) is produced from a polymer material or vulcanized rubber.

2: Refrigerant compressor (1) according to claim 1, wherein the at least one wall element (10, 11) is part of a cap (9) disposed in the housing (2) and rigidly connected with the latter.

3: Refrigerant compressor (1) according to claim 2, wherein the outer element (6) is fixed in place on the at least one wall element (10, 11).

4: Refrigerant compressor (1) according to claim 3, wherein the outer element (6) has an inner side (12) that faces the inner element (5), which side delimits a clear cross-section (13) of the outer element (6), and that the clear cross-section (13) narrows, at least in certain sections, viewed parallel to a longitudinal axis (14) of the outer element (6).

5: Refrigerant compressor (1) according to claim 4, wherein the clear cross-section (13) narrows, viewed parallel to the longitudinal axis (14) and in the direction of a center (15) of the outer element (6) that lies on the longitudinal axis (14), and increases in size in the opposite direction.

6: Refrigerant compressor (1) according to claim 4, wherein the clear cross-section (13) narrows in steps.

7: Refrigerant compressor (1) according to claim 3, wherein the outer element (6) has an outer side (16) that surrounds the inner element (5), in certain sections, and faces away from the inner element (5), which side is fixed in place, at least in certain sections, on the at least one wall element (10, 11).

8: Refrigerant compressor (1) according to claim 2, wherein the outer element (6) has an outer side (16) that surrounds the inner element (5), in certain sections, and faces away from the inner element (5), which outer side (16) contacts the at least one wall element (10) in certain sections, in the first state of the drive unit (3), and is spaced apart from the at least one wall element (10), in certain sections.

9: Refrigerant compressor (1) according to claim 2, wherein the outer element (6) has an outer side (16) that surrounds the inner element (5) in certain sections, and faces away from the inner element (5), which outer side (16) overlaps with the at least one wall element (10, 11), viewed parallel to the longitudinal axis (14), only in certain sections.

10: Refrigerant compressor (1) according to claim 1, wherein the at least one wall element is part of a housing wall (8) of the housing (2).

11: Refrigerant compressor (1) according to claim 1, wherein the outer element (6) is fixed in place on the inner element (5).

12: Refrigerant compressor (1) according to claim 11, wherein the outer element (6) has an inner side (12) that faces the inner element (5), which side is completely contacted by the inner element (5).

13: Refrigerant compressor (1) according to claim 11, wherein the outer element (6) has lamellae (17) that contact the at least one wall element (8) in the second state of the drive unit (3).

14: Refrigerant compressor (1) according to claim 13, wherein the lamellae (17) project from a basic body (18) of the outer element (6) in a normal line relative to the longitudinal axis (14).

15: Refrigerant compressor (1) according to claim 11, wherein the outer element (6) and the inner element (5) are structured in one piece.

16: Refrigerant compressor (1) according to claim 1, wherein the outer element (6) is structured in one piece.

17: Refrigerant compressor (1) according to claim 1, wherein the inner element (5) is produced from metal.
